(19) United States
(12) Patent Application Publication
(10) Pub. No.: US 2017/0057386 A1
(43) Pub. Date: Mar. 2, 2017

(54) SEAT CUSHION AIRBAG DEVICE

(71) Applicant: TOYODA GOSEI CO., LTD., Kiyosu-shi (JP)

(72) Inventors: Takanori KANTO, Kiyosu-shi (JP); Akihiro NUKAYA, Kiyosu-shi (JP)

(21) Appl. No.: 15/244,221

(22) Filed: Aug. 23, 2016

(30) Foreign Application Priority Data
Aug. 28, 2015 (JP) 2015-169693

(51) Int. Cl. B60N 2/427; B60R 21/239; B60R 21/231; B60R 21/207; B60R 21/217

(52) U.S. Cl. CPC B60N 2/42763; B60R 21/207; B60R 21/2171; B60R 21/231; B60R 21/239

(57) ABSTRACT

A seat cushion airbag device includes: an airbag disposed in a seat section of a vehicle seat; and a gas generator, the airbag including: an airbag main body; and an inner bag has gas release sections configured to release the inflation gas from the gas generator to the airbag main body in at least two positions, wherein: the inner bag and the airbag main body are inflated by the inflation gas to raise the seat surface of the seat section to regulate a restraint target object on the seat section from moving forward; and each of the gas release sections is constituted by a gas release hole, and of the gas release holes, an opening area of the gas release hole on the side closer to the blow-off opening section is set to be smaller than an opening area of the gas release hole on the remote side.

### CROSS-REFERENCE TO RELATED APPLICATION(S)

This application is based upon and claims the benefit of priority from Japanese Patent Application No. 2015-169693, filed on Aug. 28, 2015, the entire contents of which are incorporated herein by reference.

### BACKGROUND

1. Field of the Invention

The present invention relates to a seat cushion airbag device that is configured to inflate an airbag disposed in a seat section of a vehicle seat such as an automobile seat by an inflation gas to raise a seat surface, thereby regulating a restraint target object such as an occupant on the seat section from moving forward.

2. Description of the Related Art

In the vehicle, there is a problem of a phenomenon in which, when an impact is applied to the vehicle from the front by the front collision or the like, the occupant's waist restrained to the vehicle seat by a seat belt device or the like deviates from a lap belt section and moves forward (slides forward). Thus, various measures have been taken or suggested in order to suppress this phenomenon.

As one of them, there is a seat cushion airbag device applied to a vehicle seat having, as a seat section, a section in which the seat cushion is supported from the bottom by a support section of a seat frame (for example, see JP-A-2007-118816 and JP-A-2009-132245).

As illustrated in FIG. 15, the seat cushion airbag device includes an airbag 101 disposed between the support section and the seat cushion, and an elongated gas generator 106 disposed in the airbag 101 in a posture of extending in a width direction of the vehicle seat. The gas generator 106 blows off a lot of inflation gas G from a blow-off opening section 107 of one end portion more than from the other end portion.

The airbag 101 includes an airbag main body 102 constituting an outer shell portion, and an inner bag 103 disposed inside the airbag main body 102 in the state of wrapping the gas generator 106. In the inner bag 103, at two positions spaced apart from each other in the width direction of the vehicle seat, gas release holes 104 and 105 which release the inflation gas G from the gas generator 106 to the airbag main body 102 are formed. Both the gas release holes 104 and 105 are formed at mutually the same size.

When an impact is applied from the front of the vehicle seat to the vehicle by the front collision or the like, the occupant tries to move forward due to inertia. The occupant is held on the seat section by a holding action of the seat belt device. However, the waist may try to move forward depending on the occupant's posture.

Meanwhile, in the seat cushion airbag device, the inflation gas G blows off from the blow-off opening section 107 of the gas generator 106 according to the impact from the front, and the inner bag 103 is inflated. Moreover, the inflation gas G is released into the airbag main body 102 from both the gas release holes 104 and 105. The airbag main body 102 is inflated by the inflation gas G, the seat cushion is pushed up, and the seat surface of the seat section is raised. A rear vicinity portion of a knee region in a femoral region of the occupant restrained in the vehicle seat by the seat belt device is pressed upward, and the waist is pressed against the lap belt section. The performance of restraining the occupant by the lap belt section is enhanced, and the forward movement (forward sliding) of the waist is regulated.

In the related-art seat cushion airbag device, however, a lot of inflation gas G is blown off from the blow-off opening section 107 of the gas generator 106 more than from the other end portion as mentioned above. The inflation gas G flows along the inner wall of the inner bag 103 as indicated by arrows in FIG. 15. The inflation gas G reaches the gas release hole 104 on the side remote from the blow-off opening section 107 to be slower than the gas release hole 105 on the closer side. Therefore, until a certain time elapses from the jetting start time of the inflation gas G from the gas generator 106, for example, the integrated value of the inflation gas G released up to the time of jetting termination becomes larger in the gas release hole 105 on the side closer to the blow-off opening section 107 than in the gas release hole 104 on the remote side. Along with this, the total amount of heat amount released from the gas release hole 105 is larger than the total amount of heat amount released from the gas release hole 104. As a result, the heat of the inflation gas G is biased toward the airbag main body 102.

### SUMMARY

The present invention has been made in view of such circumstances, and is to provide a seat cushion airbag device that can suppress heat of the inflation gas released from the inner bag from being biased toward the airbag main body.

According to a first aspect of the invention, there is provided a seat cushion airbag device including: an airbag disposed in a seat section of a vehicle seat; and a gas generator which has an elongated shape extending in a width direction of the vehicle seat within the airbag and blows off a lot of inflation gas from a blow-off opening section of one end portion more than from the other end portion, the airbag including: an airbag main body which constitutes an outer shell portion; and an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein: the inner bag and the airbag main body are inflated by the inflation gas to raise the seat surface of the seat section to regulate a restraint target object on the seat section from moving forward; and each of the gas release sections is constituted by a gas release hole, and of the gas release holes, an opening area of the gas release hole on the side closer to the blow-off opening section is set to be smaller than an opening area of the gas release hole on the remote side.

According to the above configuration, when the impact is applied to the vehicle from the front of the vehicle seat, the restrained object on the seat section of the vehicle seat tries to move forward due to inertia.

Meanwhile, in the seat cushion airbag device, the inflation gas is supplied from the gas generator according to the impact from the front, and the inner bag is inflated. In addition, the inflation gas in the inner bag is released into the airbag main body from each gas release hole. The airbag main body is inflated by the inflation gas, the seat surface of the seat section is caused to bulge, and the forward movement (forward sliding) of the restrained object is regulated.

By the way, a lot of inflation gas is blown off from the blow-off opening section of the one end portion of the gas generator more than from the other end portion. The inflation gas flows along the inner wall of the inner bag. The inflation gas reaches the gas release hole on the remote side from the blow-off opening section to be slower than the gas release hole on the closer side.

However, the opening area of the gas release hole on the side closer to the blow-off opening section is smaller than the opening area on the gas release hole on the remote side.

Therefore, between the gas release hole on the side closer to the blow-off opening section and the gas release hole on the side remote from the blow-off opening section, a difference in integrated value of the inflation gas released from the time of the jetting start of the inflation gas from the gas generator to the passage of a certain time, for example, to the time of jetting termination decreases. Along with this, a difference between the total amount of heat amount released from the gas release hole 105 on the side closer to the blow-off opening section and the total amount of heat amount released from the gas release hole on the remote side decreases.

According to a second aspect of the invention, there is provided a seat cushion airbag device including: an airbag disposed in a seat section of a vehicle seat; and a gas generator which has an elongated shape extending in a width direction of the vehicle seat within the airbag and blows off a lot of inflation gas from a blow-off opening section of one end portion more than from the other end portion, the airbag including: an airbag main body which constitutes an outer shell portion; and an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein: the inner bag and the airbag main body are inflated by the inflation gas to raise the seat surface of the seat section to regulate a restraint target object on the seat section from moving forward; and a gas release section, of the gas release sections, on the side remote from the blow-off opening section is constituted by a gas release hole, and a gas release section, of the gas release sections, on the side closer to the blow-off opening section is constituted by a fragile section which has strength lower than other positions of the inner bag and is ruptured by the inflation gas to form an opening section in the gas release section.

According to the above configuration, of the gas release sections, the gas release section on the side remote from the blow-off opening section of the gas generator is constituted by a gas release hole, and is opened. Therefore, although the gas release section (the gas release hole) is away from the blow-off opening section, the inflation gas blown off from the blow-off opening section can pass through.

In contrast, the gas release section on the side closer to the blow-off opening section is constituted by a fragile section. Although the fragile section is close to the blow-out opening section, until it is ruptured by inflation gas, the fragile section regulates the passage of the inflation gas through the gas release section. Further, when the internal pressure of the inner bag rises with the supply of the inflation gas and the fragile section is ruptured by the inflation gas, an opening section is formed in the gas discharge section. The inflation gas more than before ruptured can pass through the opening section of the gas release section.

Therefore, between the gas release section (fragile section) on the side closer to the blow-off opening section and the gas release section (gas release hole) on the side remote from the blow-off opening section, a difference in the integrated value of the inflation gas released from the time of jetting start of the inflation gas from the gas generator to the passage of a certain period of time, for example, to the jetting termination time decreases. Along with this, a difference between the total amount of heat amount released from the gas release section (the fragile section) on the side closer to the blow-off opening section and the total amount of heat amount released from the gas release section (the gas release hole) on the remote side decreases.

A third aspect of the invention provides the seat cushion airbag device according to the second aspect, wherein: the inner bag is formed with a plurality of three or more slits extending radially from each other from starting points that are set at positions spaced apart from each other; and the fragile section is constituted by the plurality of slits, and a joining section that is made up of a region surrounded by the starting points of all the slits and connects all the slits

According to the above configuration, the joining section of the fragile section is not ruptured by inflation gas when the internal pressure of the inner bag is low. All the slits are continuously connected by the joining section. Deformation of the section between the adjacent slits is regulated by the joining section. Therefore, the passage of the inflation gas through the gas release section is regulated. However, a small amount of inflation gas can pass through the slits.

When the internal pressure of the inner bag rises with the supply of the inflation gas and the joining section is ruptured by the inflation gas, all the slits are not connected. When the section between the adjacent slits is deformed, an opening section is formed in the gas discharge section. Therefore, the inflation gas more than before ruptured can pass through the opening of the gas release section.

According to a fourth aspect of the invention, there is provided a seat cushion airbag device including: an airbag disposed in a seat section of a vehicle seat; and a gas generator which has an elongated shape extending in a width direction of the vehicle seat within the airbag and blows off a lot of inflation gas from a blow-off opening section of one end portion more than from the other end portion, the airbag including: an airbag main body which constitutes an outer shell portion; and an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein: the inner bag and the airbag main body are inflated by the inflation gas to raise the seat surface of the seat section to regulate a restraint target object on the seat section from moving forward; and each of the gas release sections is constituted by the gas release holes, the gas release hole on the side remote from the blow-off opening section is opened, a lid sheet is located at a position of closing the gas release hole on the side closer to the blow-off opening section, and the lid sheet surrounds the gas release holes and is connected to the inner bag by an annular joining section which is ruptured by the inflation gas.

According to the above configuration, of the gas release sections, the gas release section on the side remote from the blow-off opening section of the gas generator is constituted by a gas release hole, and is opened. Therefore, although the gas release section (the gas release hole) is remote from the blow-off opening section, the inflation gas blown off from the blow-off opening section can pass through.

In contrast, although the gas release section on the side closer to the blow-off opening section is constituted by a gas release hole, it is blocked by the lid sheet. Moreover, the lid sheet is joined to the inner bag by the annular joining section to regulate the movement. Therefore, until the force of magnitude enough to rupture the annular joining section through the lid sheet by the inflation gas, the gas release hole is maintained in a state of being blocked by the lid sheet. The passage of the inflation gas through the gas release hole is regulated by the lid sheet and the annular joining section.

When the internal pressure of the inner bag rises with the supply of the inflation gas, the force applied to the annular joining section through the lid sheet increases, and at least a portion of the annular joining section is ruptured, the joining force caused by the annular joining section applied by that time decreases, at least a portion of the gas release hole is opened, and a lot of inflation gas more than before rupturing of the annular joining section can pass through the gas release hole.

Therefore, between the gas release section on the side closer to the blow-off opening section and the gas release section on the side remote from the blow-off opening section, a difference in the integrated value of the inflation gas released from the time of jetting start of the inflation gas from the gas generator to the passage of a certain period of time, for example, to the jetting termination time decreases. Along with this, a difference between the total amount of heat amount released from the gas release section on the side closer to the blow-off opening section and the total amount of heat amount released from the gas release section on the remote side decreases.

According to a fifth aspect of the invention, there is provided a seat cushion airbag device including: an airbag disposed in a seat section of a vehicle seat; and a gas generator which has an elongated shape extending in a width direction of the vehicle seat within the airbag and blows off a lot of inflation gas from a blow-off opening section of one end portion more than from the other end portion, the airbag including: an airbag main body which constitutes an outer shell portion; and an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein: the inner bag and the airbag main body are inflated by the inflation gas to raise the seat surface of the seat section, thereby regulating a restraint target object on the seat section from moving forward; and each of the gas release sections is constituted by gas release holes, lid sheets are disposed at positions for closing each gas release hole, the lid sheets surround the gas release holes and are joined to the inner bag by the annular joining section ruptured by the inflation gas, and the lid sheet on the side closer to the blow-out opening section is joined to the inner bag by an annular joining section which is ruptured with force greater than the lid sheet on the remote side.

According to the above configuration, all the gas release sections are constituted by the gas release holes and are blocked by the lid sheets. Moreover, the lid sheets are joined to the inner bag by the annular joining section to regulate the movement. Therefore, until the force of magnitude enough to rupture the annular joining section through the lid sheet by the inflation gas, each gas release hole is maintained in a state of being blocked by the lid sheet. The passage of the inflation gas through the gas release holes is regulated by the lid sheet and the annular joining section.

However, in the gas release hole on the side of closer to the blow-off opening section of the gas generator, the lid sheet is joined to the inner bag by the annular joining section which is ruptured with force greater than the gas release hole on the remote side.

Therefore, when the internal pressure of the inner bag rises with the supply of the inflation gas and the force applied to the annular joining section through each lid sheet increases, only in the gas release portion on the side remote from the blow-off opening section, at least a portion of the annular joining section joined to the lid sheet is ruptured. The joining force caused by the annular joining section applied by that time decreases, at least a portion of the gas release hole is opened, and a lot of inflation gas more than before rupturing of the annular joining section can pass through the gas release hole.

Even after that, when the internal pressure of the inner bag continues to rise with the supply of the inflation gas, even in the gas release section on the side closer to the blow-off opening section, at least a portion of the annular joining section joined to the lid sheet is ruptured. The joining force caused by the annular joining section applied by that time decreases, at least a portion of the gas release hole is opened, and a lot of inflation gas more than before rupturing of the annular joining section can pass through the gas release hole.

In this way, at the time of jetting start of the inflation gas from the gas generator, all the gas release holes are also blocked by the lid sheets. However, the gas release hole on the side remote from the blow-off opening section is opened, and the gas release hole on the side closer to the blow-out opening section is opened later than that.

Therefore, between the gas release section on the side closer to the blow-off opening section and the gas release section on the side remote from the blow-off opening section, a difference in the integrated value of the inflation gas released from the time of jetting start of the inflation gas from the gas generator to the passage of a certain period of time, for example, to the jetting termination time decreases. Along with this, a difference between the total amount of heat amount released from the gas release section on the side closer to the blow-off opening section and the total amount of heat amount released from the gas release section on the remote side decreases.

A sixth aspect of the present invention provides the seat cushion airbag device according to any one of the first, second, third, fourth and fifth aspects, wherein: the gas generator includes: a retainer which has a cylindrical shape extending in the width direction of the vehicle seat and has the blow-off opening section at one end portion thereof; and an inflator which has an elongated shape extending in the width direction of the vehicle seat and has a gas jetting section at one end portion; and the inflator is disposed inside the retainer in a state in which the provision side of the gas jetting section is made to coincide with the provision side of the blow-off opening section of the retainer, in the width direction of the vehicle seat.

According to the above configuration, when inflation gas is jetted from the gas release section of the inflator, a lot of the inflation gas blows off from the blow-off opening section at one end portion of the retainer along the inner wall of the retainer. The inflation gas flows along the inner wall of the inner bag, first reaches the gas release section on the side closer to the blow-off opening section, of the gas release sections, and after that, reaches the gas release section on the side remote from the blow-off opening section.

According to the seat cushion airbag device, it is possible to suppress the heat of the inflation gas released from the inner bag from being biased to the airbag main body.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a diagram illustrating a first embodiment of a seat cushion airbag device, and a side cross-sectional view illustrating a vehicle seat equipped with the device, with an occupant and a seat belt device;

FIG. 2 is an enlarged partial side cross-sectional view illustrating a part X in FIG. 1;

FIG. 3 is a perspective view illustrating the vehicle seat and the seat belt device in FIG. 1;

FIG. 4 is a partially enlarged cross-sectional side view illustrating a state in which the airbag is fastened to a receiving recess of the seat bag in FIG. 2;

FIG. 5 is a diagram illustrating the airbag module in the first embodiment, and a bottom view illustrating a state before a flap section of the airbag main body and of the inner flap section of the inner bag are folded downward and rearward;

FIG. 6 is a bottom view illustrating the airbag module in which flap section and the inner flap section are folded downward and rearward and engaged with the front end portion of the airbag main body in FIG. 5;

FIG. 7 is a bottom view of each component (an airbag main body, an inner bag and a gas generator) of the airbag module in FIG. 5;

FIG. 8 is a developed view of each piece used in the airbag main body and the inner bag of FIG. 7 and a side view of the gas generator;

FIG. 9 is a partially cross-sectional side view illustrating a state in which the inner bag and the airbag main body are inflated and a seat surface of the seat section is caused to bulge from the state of FIG. 2;

FIG. 10 is a partial bottom cross-sectional view illustrating an internal structure of the airbag module of FIG. 6;

FIG. 11 is a characteristic diagram illustrating a relationship between time and an amount of inflation gas jetted from the inflator in the first embodiment;

FIG. 12 is a diagram illustrating a seat cushion airbag device of a second embodiment, Section (a) of FIG. 12 illustrates a partial bottom cross-sectional view illustrating the internal state of the inner bag at the beginning of the jetting period of the inflation gas, and Section (b) of FIG. 12 is a partial bottom cross-sectional view illustrating the internal state of the inner bag after that;

FIG. 13 is a diagram illustrating a seat cushion airbag device of a third embodiment, Section (a) of FIG. 13 illustrates a partial bottom cross-sectional view illustrating an internal state of the inner bag at the beginning of the jetting period of the inflation gas, and Section (b) of FIG. 13 is a partial bottom cross-sectional view illustrating an internal state of the inner bag after that;

FIG. 14 is a diagram illustrating a seat cushion airbag device of a fourth embodiment, Section (a) of FIG. 14 illustrates a partial bottom cross-sectional view illustrating an internal state of the inner bag at the beginning of the jetting period of the inflation gas, and Section (b) of FIG. 14 is a partial bottom cross-sectional view illustrating an internal state of the inner bag after that; and

FIG. 15 is a partial bottom cross-sectional view illustrating an internal structure of a related-art seat cushion airbag device.

### DETAILED DESCRIPTION OF THE INVENTION

### First Embodiment

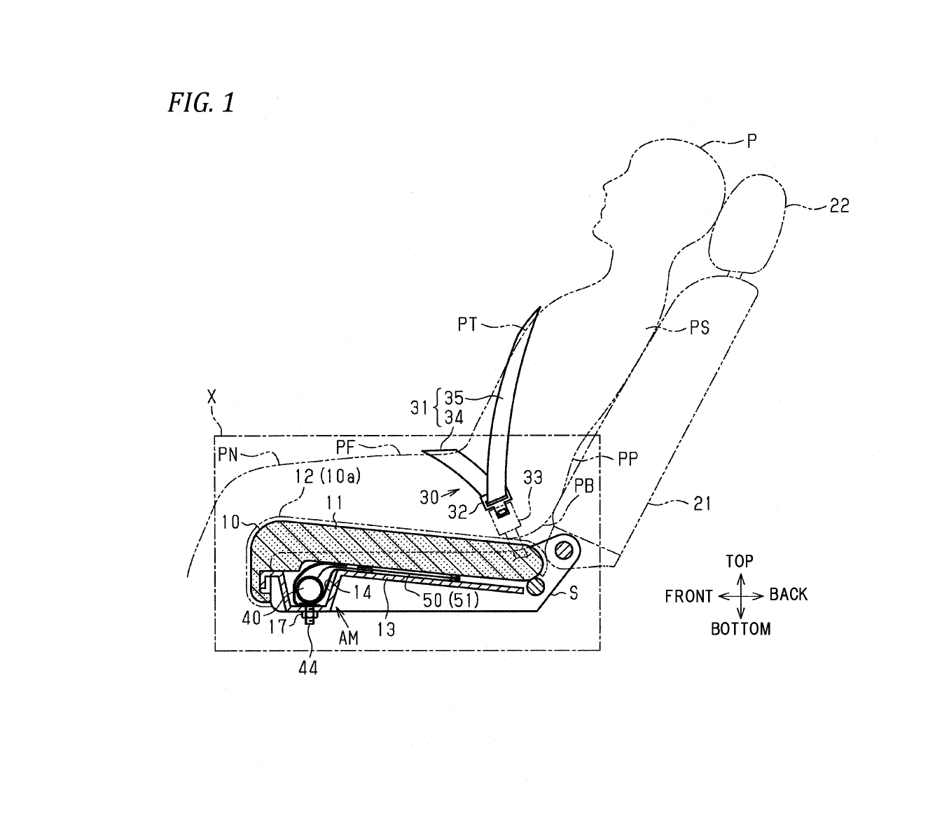

Hereinafter, a first embodiment embodied in a seat cushion vehicle airbag device (hereinafter, simply referred to as an “airbag device”) will be described with reference to FIGS. 1 to 11.

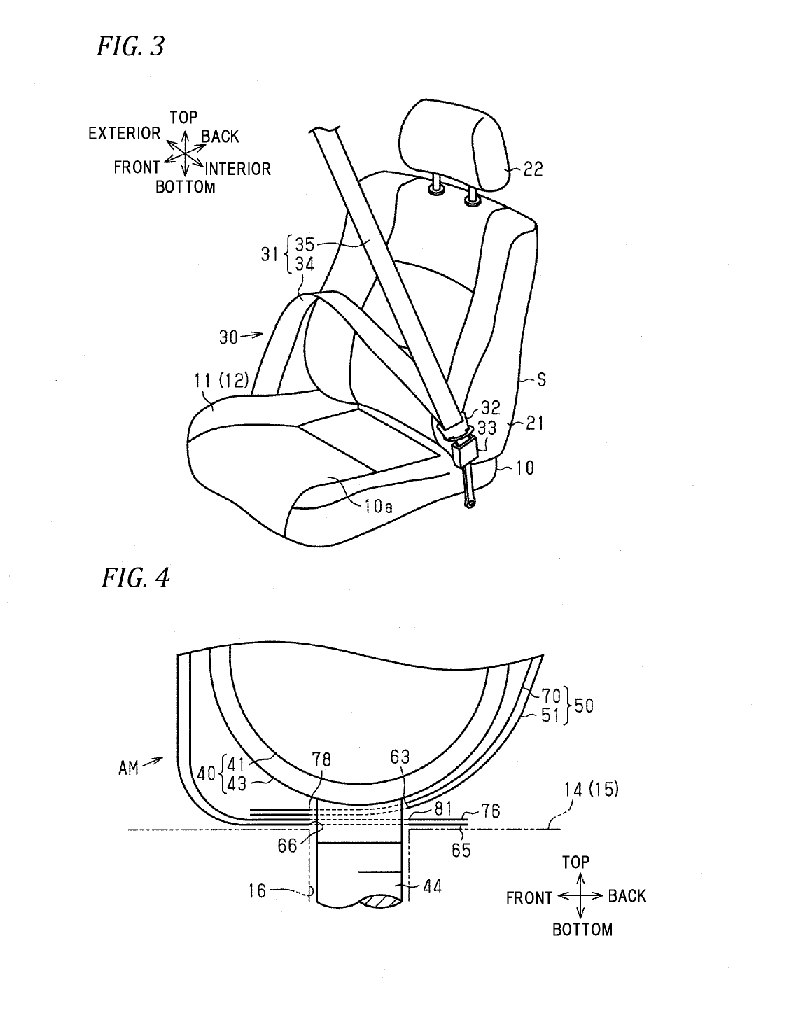

In the following description, a forward direction of a vehicle is described as a front, and front, back, top, bottom left and right are defined based on the forward direction. In FIG. 3, “interior” illustrates a vehicle inside, and an “exterior” illustrates a vehicle outside. The vehicle inside is a side closer to a center position in a width direction of the vehicle (a vehicle width direction), and the vehicle outside is a side remote from the central position. In addition, it is assumed that a passenger having the same physique as a collision test dummy is seated on the vehicle seat.

As illustrated in FIGS. 1 and 3, a vehicle seat S as an automobile seat is disposed in a vehicle. The vehicle seat S includes a seat section (a seat cushion) 10, a backrest section (a seat pack) 21 that stands from the rear side of the seat section 10 and is disposed to be able to adjust an inclination angle, and a headrest 22 disposed on the upper side of the backrest section 21. The vehicle seat S is installed in the vehicle in a posture in which the backrest section 21 faces the front of the vehicle. A longitudinal direction of the vehicle seat S thus installed is consistent with the longitudinal direction of the vehicle, and the width direction of the vehicle seat S is consistent with the vehicle width direction.

The seat section 10 is a portion in which an occupant P as an object (a restraint target object) restrained by the airbag device is seated. The seat section 10 includes a seat cushion 11, and a seat pan 13 made of a steel plate as the supporting section for supporting the seat cushion 11 from the lower side. The seat cushion 11 is covered by a cover 12 made of fabric or leather. In a front portion of the seat pan 13, a receiving recess 14 for receiving a portion (front) of the airbag module AM to be described later is formed. The receiving recess 14 extends in the vehicle width direction in a state in which the upper surface is opened.

A vehicle is equipped with a seat belt device 30 for restraining the occupant P seated on the vehicle seat S.

The seat belt device 30 includes a belt-like webbing 31 for restraining the occupant P, a tongue 32 which is mounted with respect to the webbing 31 to be movable in the lengthwise direction, and a buckle 33 which is disposed in the vehicle interior of the seat section 10 and to which the tongue 32 is detachably mounted. The webbing 31 is configured so that its one end portion is fixed to the vehicle outside of the seat section 10, and the other end portion is wound by a belt winding device (not illustrated) disposed outside the vehicle. In the seat belt device 30, by making the tongue 32 slide along the webbing 31, it is possible to change each length of a lap belt section 34 and a shoulder belt section 35.

The lap belt section 34 is a section in the webbing 31 from the tongue 32 to the end portion (fixing end) of the webbing 31, and is stretched from one side of a waist PP of the seated occupant P to the other side via the front of the waist PP. The shoulder belt section 35 is a section in the webbing 31 from the tongue 32 to the belt winding device, and is obliquely stretched from a shoulder PS of the seated occupant P to the side of the waist PP via the front of the chest PT.

The vehicle is provided with an airbag device for suppressing a submarine phenomenon. The submarine phenomenon is a phenomenon in which, when impact is applied to the vehicle from the front by front collision or the like, the waist PP of the occupant P restrained in the vehicle seat S by the seat belt device 30 moves forward (forward slide) away from the lap belt section 34.

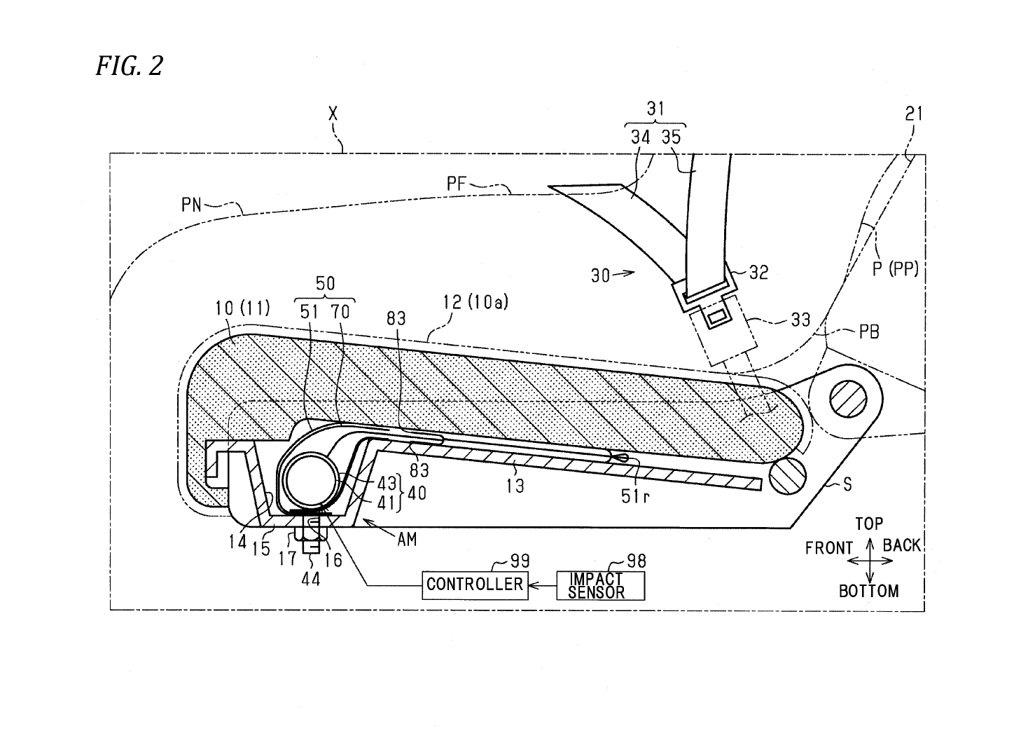

FIG. 2 illustrates a schematic configuration of the airbag device. However, the illustration of the details is omitted in FIG. 2. As illustrated in FIG. 2, the airbag device includes an airbag module AM, an impact sensor 98 and a controller 99.

The airbag module AM is provided with a gas generator 40 and an airbag 50. Further, the airbag 50 is provided with an airbag main body 51 and an inner bag 70, and is disposed inside the seat section 10 of the vehicle seat S, and more precisely, between the seat pan 13 and the seat cushion 11. Next, various parts that make up the airbag module AM will be described.

<Configuration of Gas Generator 40>

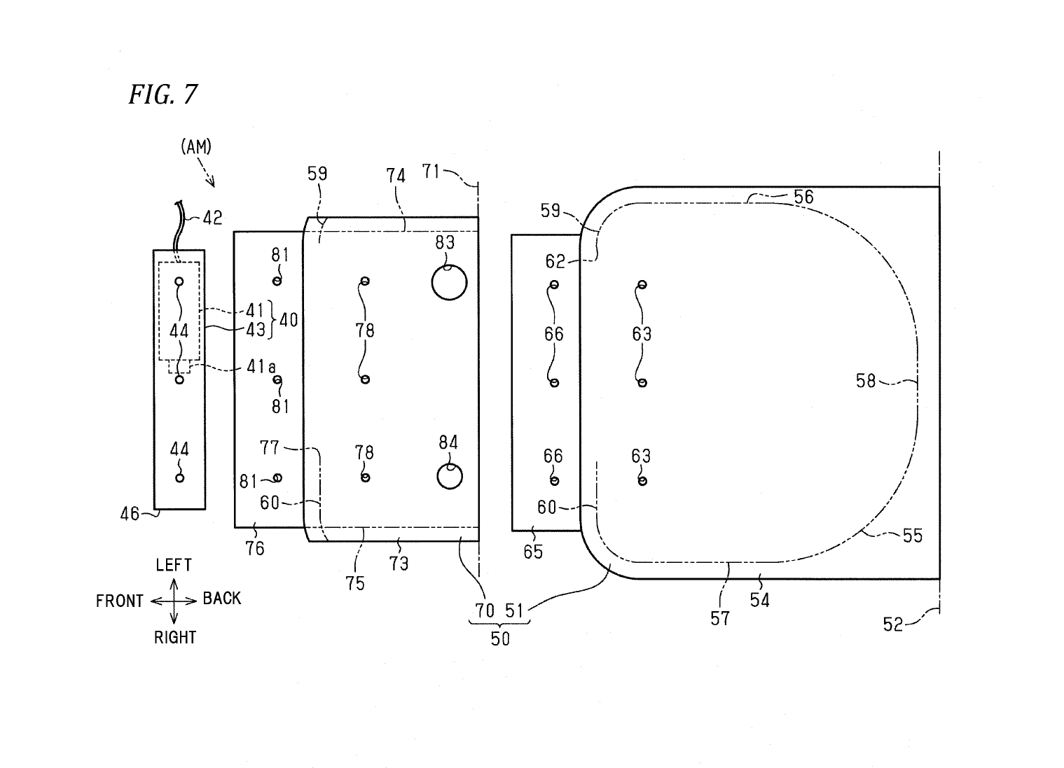

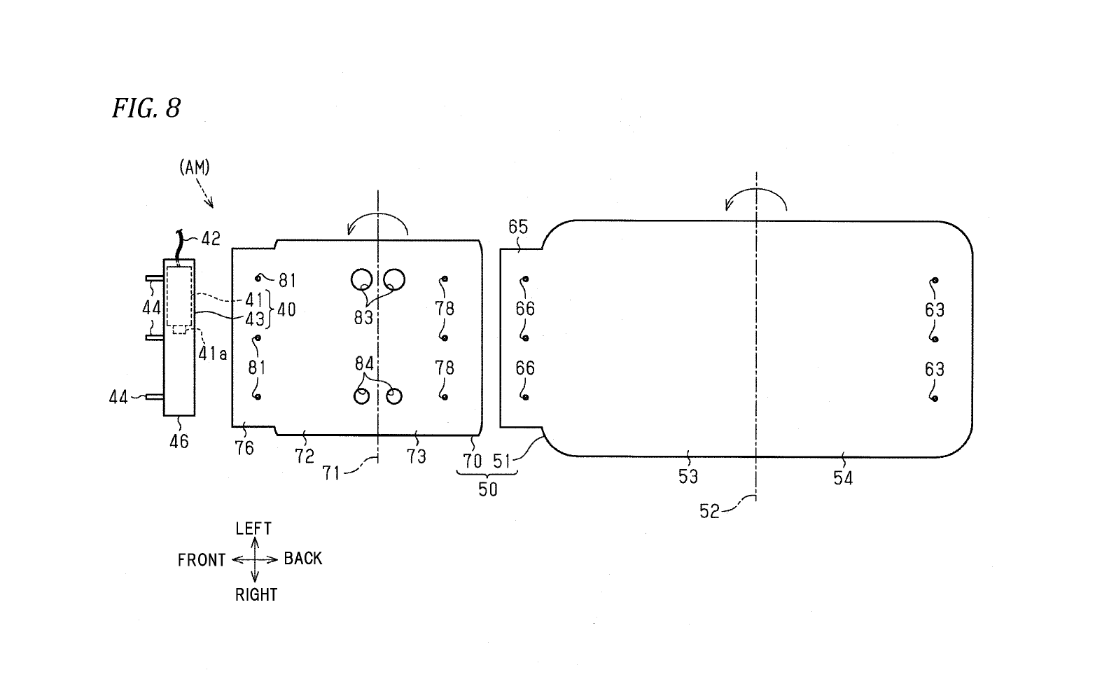

As illustrated in FIGS. 7 and 8, the gas generator 40 is intended to supply the inflation gas G to the airbag 50, and includes an inflator 41, and a retainer 43 that covers the inflator 41. Here, a type referred to as a pyro type is used as the inflator 41. The inflator 41 has an elongated shape (substantially columnar shape) extending in the vehicle width direction, and a gas generating agent (not illustrated) which generates inflation gas is received inside the inflator. A gas jetting section 41a for jetting the inflation gas G is provided at one end portion in the vehicle width direction of the inflator 41.

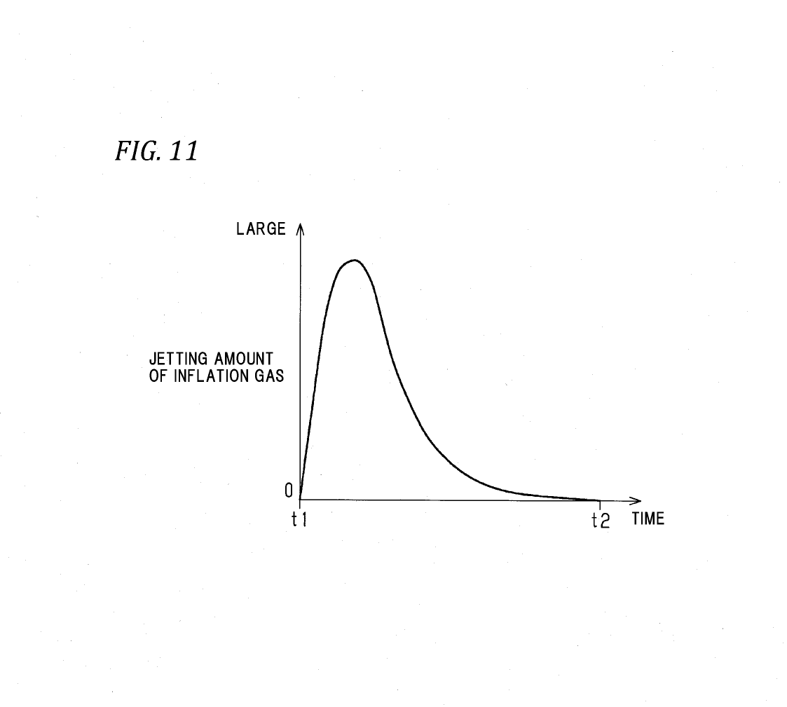

FIG. 11 illustrates a relationship between the time and a jetting amount of the inflation gas. In FIG. 11, the inflation gas G starts to be jetted at a timing t1. The jetting amount increases with the passage of time after the time of jetting start (timing t1). The jetting amount is turned from increase to decrease after reaching the maximum level, and decreases with the passage of time. Further, jetting of the inflation gas G is completed at a timing t2. The inflation gas G is jetted from the inflator 41 in such jetting characteristics.

As the inflator 41, a type different from the above pyro type may be used. As such a type, a stored gas type for jetting the inflation gas by rupturing partition walls of a high-pressure gas cylinder filled with a high-pressure gas through gun powder or the like, and a hybrid type in the form of combining both the pyro type and the stored gas type are used.

Meanwhile, most of the retainer 43 as illustrated in FIGS. 7 and 8 are formed by bending a plate material such as a metal plate. The retainer 43 has a substantially elongated cylindrical shape extending in the vehicle width direction, and both end portions thereof are opened. On the lower surface of the retainer 43, at the plurality of positions (three positions in the first embodiment) spaced apart from each other in the vehicle width, bolts 44 extending downward are fixed.

The inflator 41 is disposed on one side (left side) in the vehicle width direction of the retainer 43. The gas jetting section 41a of the inflator 41 is positioned near the center portion in the lengthwise direction of the retainer 43. A harness 42 extending from the inflator 41 is drawn from the one (left) end portion of the retainer 43 to the outside of the retainer 43.

In the gas generator 40, the inflator 41 having the gas jetting section 41a only at one end portion thereof is used. Since the gas generator 40 has the aforementioned configuration, a lot of the inflation gas G is blown off from the right end portion of the retainer 43 more than from the left end portion. Therefore, of both end portions of the retainer 43, the right end portion from which a lot of inflation gas G is blown is set as a blow-off opening section 46 to distinguish the right end portion from the left end portion. Of the vehicle width direction, the side provided with the gas jetting section 41a of the inflator 41 and the side provided with the blow-off opening section 46 of the retainer 43 are coincident with each other.

The inflator 41 may have a configuration that is provided integrally with the retainer 43.

<Configuration of Airbag Main Body 51>

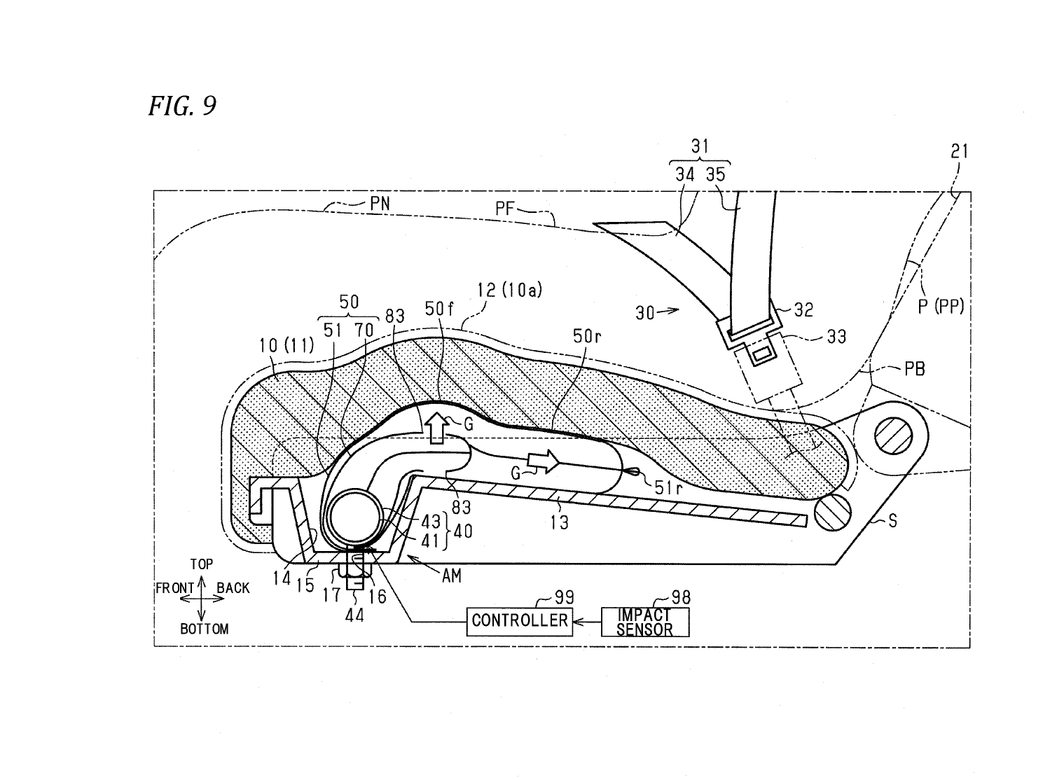

The airbag main body 51 is a member which constitutes an outer shell portion of the airbag 50, and functions as raising a seat surface 10a of the seat section 10 by being inflated (see FIG. 9). The airbag main body 51 is formed by folding a sheet having a substantially elongated rectangular in the longitudinal direction or a plurality of fabric pieces (a base fabric, also referred to as a panel fabric or the like) superimposed with each other twice, along a folding line 52 set at the central portion thereof and vertically superposing them, and by joining the superimposed portions in a bag shape. Here, in order to distinguish the two superimposed sections of the airbag main body 51, a section located on the upper side is referred to as an upper fabric section 53, and a section located on the lower side is referred to as a lower fabric section 54. As the upper fabric section 53 and the lower fabric sections 54, it is preferable to use a material with high strength and flexibility, such as a woven fabric or the like formed, for example, using polyester yarn, a polyamide yarn or the like.

The joining between the upper fabric section 53 and the lower fabric section 54 is performed in a peripheral edge joining section 55 provided in their peripheral edge sections. In other words, the peripheral edge sections of the lower fabric sections 54 and the peripheral edge section and the upper cloth portion 53 are joined to each other by the peripheral edge joining section 55. In the first embodiment, the peripheral edge joining section 55 is formed by sewing (sewn by a yarn) a portion excluding the front end portion, of each peripheral edge section of the upper fabric section 53 and the lower fabric sections 54. The same is also applied to side edge joining sections 74 and 75 and annular joining sections 92 and 94 which will be described later.

The peripheral edge joining section 55 is constituted by a pair of side edge joining sections 56 and 57, the rear joining section 58 and a pair of front joining sections 59 and 60. Both side edge joining sections 56 and 57 extend in the longitudinal direction in a state of being spaced apart from each other in the vehicle width direction. The rear joining section 58 has an arc shape bulging backward. Both end portions of the rear joining sections 58 are connected to the rear end portions on the side edge joining sections 56 and 57. Further, the rear joining section 58 may be formed in a shape different from the arc shape, for example, a linear shape.

Each of the front end joining sections 59 and 60 extend toward the front ends of the facing front side edge joining sections 57 and 56 from each on the side edge joining sections 56 and 57.

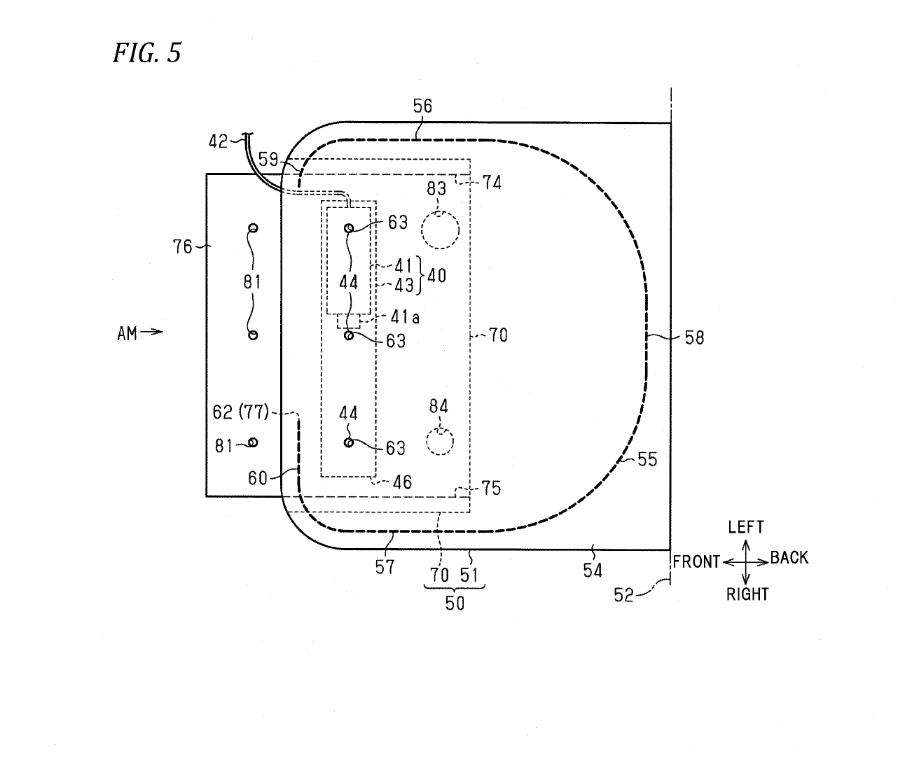

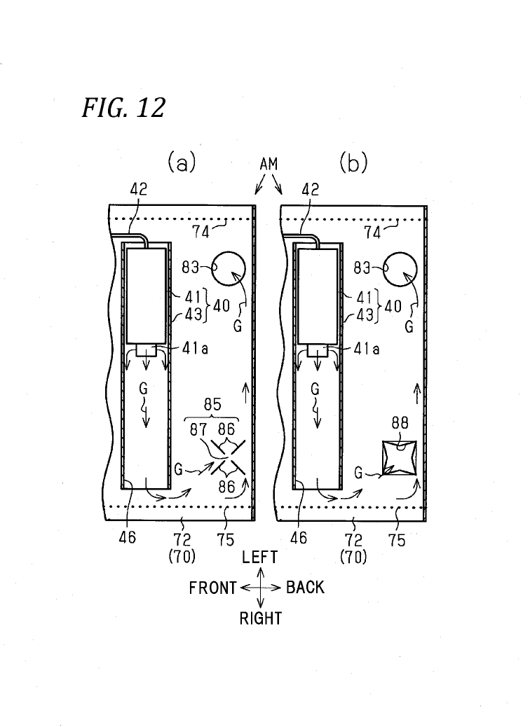

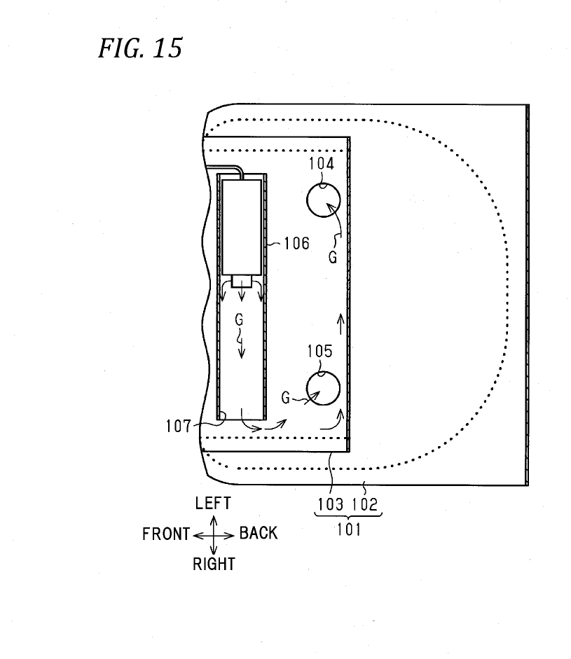

In regard to the aforementioned sewing, in FIGS. 5, 6 and 10, the sewing section is represented by three line types. The same is also applied to FIGS. 12 to 14 used in the description of other embodiments and FIG. 15 used in the description of the related art.

A first line type is a line in which thick lines of predetermined length are expressed by being intermittently arranged, and this illustrates a state in which a sewing yarn is viewed from the top or the bottom (see, for example, peripheral edge joining section 55 in FIG. 5). A second line type is a line in which thin lines of predetermined length (longer than a general dashed line) are expressed by being intermittently arranged, and this illustrates a state of a sewing yarn which is located, for example, between the upper fabric section 53 and the lower fabric section 54 and is not directly seen (hidden) (see the side edge joining sections 74 and 75 and the like in FIG. 5). A third line type is a line in which a point is expressed by being arranged at a fixed interval, and this illustrates a cross-section of a sewing yarn on a surface that passes through the sewing section (see the peripheral edge joining section 55, the side edge joining sections 7 and 75, or the like).

In the first embodiment, since a configuration in which the fabric pieces are folded twice is adopted as the airbag main body 51, it is possible to omit joining (sewing) using the peripheral edge joining section 55 (the rear joining section 58) in the vicinity of the folding line 52.

In the first embodiment, although the fabric piece is folded twice so that the folding line 52 is positioned at the rear end portion of the airbag main body 51, the fabric piece may be folded twice so that the folding line 52 is located at the other end portion. The airbag main body 51 may be made of a plurality of fabric pieces which are divided along the folding line 52. In this case, the airbag main body 51 is formed by superimposing a plurality of fabric pieces in the vertical direction, and by joining the fabric piece in a bag shape. As the number of used fabric pieces increases, the strength of the airbag main body 51 increases. Such a change can also be similarly applied to the inner bag 70.

The peripheral edge joining section 55 may be formed by joining means different from the sewing using the sewing yarn, for example, bonding using an adhesive, welding or the like. The same is also applied to side edge joining sections 74 and 75 and annular joining sections 92 and 94 which will be described later.

As illustrated in FIGS. 5 and 7, in the airbag main body 51 in which the upper fabric section 53 and the lower fabric section 54 are joined by the peripheral edge joining section 55, a position surrounded by the peripheral edge joining section 55 becomes a position (inflation section) that is inflated by the inflation gas G.

A position which is not joined by the peripheral edge joining section 55 at the front end portion of the airbag main body 51, that is, between the lower fabric sections 54 and the upper fabric section 53, a position interposed between both the front joining sections 59 and 60 constitutes an outer insertion port 62.

In the lower fabric sections 54, at a position (front end portion of the lower cloth portion 54) spaced apart rearward from the outer insertion port 62, at a plurality of positions (three positions) spaced apart from each other in the vehicle width direction, insertion holes 63 for inserting the bolts 44 of the gas generator 40 are formed.

As illustrated in FIGS. 7 and 8, at the front end portion of the upper fabric section 53, the flap section 65 which protrudes forward is formed integrally. The position provided with the flap section 65 is a front side of the outer insertion port 62. The flap section 65 is covered with the front end portion of the airbag main body 51 in the state of blocking the outer insertion port 62.

In the flap section 65, at the plurality of positions (three positions) spaced from each other in the vehicle width direction, locking holes 66 for locking the flap section 65 to the bolt 44 are formed.

The locking holes 66 and the bolts 44 constitute a holding section which holds the flap section 65 in the state of being covered with the front end portion of the airbag main body 51.

From the point of view of the inflated form, as illustrated in FIG. 9, the airbag main body 51 has a configuration that includes a rear inflation section 50r that is inflated near the bottom of the femoral region PF of the occupant P, and a front inflation section 50f which is inflated to a position higher than the rear inflation section 50r near the bottom of the knee PN of the occupant P.

<Configuration of Inner Bag 70>

As illustrated in FIGS. 7 and 8, the inner bag 70 is a member constituting the airbag 50 together with the airbag main body 51, and is arranged in the airbag main body 51 (the front inflation section 500 to wrap the gas generator 40. The inner bag 70 is formed by folding a sheet or a plurality of fabric pieces superimposed with each other twice, along a folding line 71 set at the central portion thereof and vertically superposing them, and by joining the superimposed portions in a bag shape. The fabric piece is formed in an elongated rectangular shape in the longitudinal direction by the same material as the airbag main body 51. Here, in order to distinguish the two superimposed sections of the inner bag 70, a section located on the upper side is referred to as an upper fabric section 72, and a section located on the lower side is referred to as a lower fabric section 73.

The joining between the upper fabric section 72 and the lower fabric section 73 is performed by a pair of side edge joining sections 74 and 75. Each on the side edge joining sections 74 and 75 extend in the longitudinal direction along the side edge section in the vehicle width direction of the upper inner fabric section 72 and the lower inner fabric section 73.

In the inner bag 701 in which the upper fabric section 72 and the lower fabric section 73 are joined by the pair of side edge joining sections 74 and 75, a position surrounded by both the side edge joining sections 74 and 75 becomes a position (an inflation section) that is inflated by the inflation gas G.

In the first embodiment, although a configuration in which the fabric sheet is folded twice is adopted as the inner bag 70, joining may be performed by newly providing a joining section extending along the folding line 71 in the vicinity of the folding line 71 in addition to the both side edge joining sections 74 and 75.

An inner flap section 76 which protrudes forward is formed integrally at the front end portion of the upper inner fabric section 72. A position provided with the inner flap section 76 is a front side of the inner insertion port 77 to be described later. The inner flap section 76 has substantially the same shape and size as the above-described flap section 65. The inner flap section 76 is covered with the front end portion of the airbag main body 51 in the state of blocking the inner insertion port 77.

As illustrated in FIGS. 5 and 7, the inner bag 70 is disposed in the first half portion of the airbag main body 51 in the state superimposing the inner flap section 76 onto the flap section 65 of the airbag main body 51. Further, the upper inner fabric section 72 and the lower inner fabric section 73 are joined (sewn together) with the upper fabric section 53 and the lower fabric sections 54 by both the front joining sections 59 and 60 of the peripheral edge joining section 55. In this way, the inner bag 70 is attached to the airbag main body 51.

An inner insertion port 77 is formed at a location interposed by both the front joining sections 59 and 60 between the upper inner fabric section 72 and the lower inner fabric section 73. The inner insertion port 77 is located within the outer insertion port 62 of the airbag main body 51 as described above and is surrounded by the outer insertion port 62 to constitute the insertion port of the front end portion of the airbag 50 together with the outer insertion port 62.

The insertion port constituted by the outer insertion port 62 and the inner insertion port 77 is used to insert the gas generator 40 into the airbag 50 or pull the harness 42 of the inserted gas generator 40 to the outside of the airbag 50.

In the front end portion of the lower inner fabric section 73, at a plurality of positions (three positions) spaced apart from each other in the vehicle width direction, inner insertion holes 78 for inserting the bolts 44 are formed.

Moreover, in the inner flap section 76, at a plurality of positions (three positions) spaced apart from each other in the vehicle width direction, inner locking holes 81 for locking the inner flap section 76 to the bolts 44 are formed.

The inner locking holes 81 and the bolts 44 constitute an inner holding section that holds the inner flap section 76 in the state of being covered with the front end portion of the airbag main body 51.

As illustrated in FIGS. 7 and 8, in the inner bag 70 in the state of being folded twice, at the two positions spaced apart from each other in the vehicle width direction at the rear portion of each of the upper inner fabric section 72 and the lower inner fabric section 73, gas release sections of the inflation gas G are provided. Therefore, the four gas release sections are provided in the overall inner bag 70. All the gas release sections are constituted by the gas release holes 83 and 84 formed of round holes. Each of the gas release holes 83 and 84 communicates with the inside and outside of the inner bag 70, and is used to release the inflation gas G blown off from the gas generator 40 to the airbag main body 51.

In the first embodiment, of the two gas release holes 83 and 84, an opening area of the gas release hole 84 on the side closer to the blow-off opening section 46 of the gas generator 40 is set to be smaller than an opening area of the gas release hole 83 on the side remote from the blow-off opening section 46.

<Attachment Aspect of Gas Generator 40 with Respect to Airbag 50>

As illustrated in FIGS. 5 and 7, the gas generator 40 is inserted into the inner bag 70 inside the inner airbag main body 51 through the inner insertion port 77 and the outer insertion port 62. The gas generator 40 is arranged in a posture of extending in the vehicle width direction. Each bolt 44 in the gas generator 40 is inserted into the corresponding inner insertion hole 78 and the insertion hole 63.

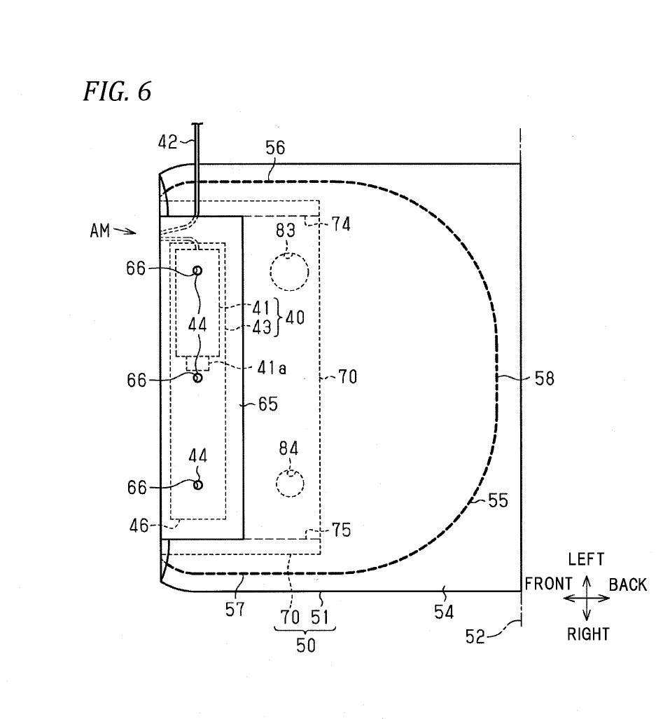

Furthermore, as illustrated in FIGS. 4 and 6, the inner flap section 76 of the inner bag 70 and the flap section 65 of the airbag main body 51 are folded back downward and rearward and are covered with the front end portion of the airbag main body 51. The bolts 44 are inserted with respect to the inner locking hole 81 of the inner flap section 76 and the locking hole 66 of the flap section 65. The inner flap section 76 and the flap section 65 are locked with the bolt 44 by the insertion. The outer insertion port 62 of the airbag main body 51 and the inner insertion port 77 of the inner bag 70 are blocked by the locking, and the flap section 65 and the inner flap section 76 are held in the state of being covered with the front end portion of the airbag main body 51.

Furthermore, the harness 42 is drawn out to the outside of the airbag 50 through the inner insertion port 77 and the outer insertion port 62.

<Arrangement Aspect of Airbag and Module AM>

As illustrated in FIGS. 2 and 4, the airbag module AM is arranged inside the seat section 10, while locating the flap section 65 and the inner flap section 76 on the lower side. The front portion of the airbag 50 in which the gas generator 40 is disposed is received in the receiving recess 14 of the seat pan 13. In the airbag 50, the locations other than front portion are disposed between the seat cushion 11 and the seat pan 13, while being deployed in a planar shape without being filled with the inflation gas G. The rear end portion 51r of the airbag main body 51 in the deployed state is located below a boundary between the femoral region PF and the shoulder PB of the occupant P seated on the seat section 10.

<Assembly Aspect of Airbag Module AM>

Each of the bolts 44 projecting downward from the airbag 50 is inserted into the through hole 16 drilled in the bottom 15 of the receiving recess 14. Further, when nuts 17 are screwed to the bolts 44 from the bottom, the gas generator 40 is locked to the receiving recess 14 together with the airbag 50. The front portion of the airbag 50 is pressed against the bottom 15 of the receiving recess 14, and the insertion port (the inner insertion port 77 and the outer insertion port 62) is in a state of being blocked. At this time, the bolts 44 and the nuts 17 serve to attach the airbag main body 51, the inner bag 70 and the gas generator 40 to the vehicle (the receiving recess 14 of the seat pan 13), and serve to hold the flap section 65 and the inner flap section 76 in the state of folding back.

As described above, the airbag device includes an impact sensor 98 and a controller 99 illustrated in FIG. 2 in addition to the airbag module AM. The impact sensor 98 is made up of an acceleration sensor or the like, and is attached to the front bumper (not illustrated) or the like of the vehicle to detect an impact applied to the front bumper or the like from the front in order to detect a front collision of the vehicle. The controller 99 controls the operation of the inflator 41 based on a detection signal from the impact sensor 98.

As described above, the airbag device of the first embodiment is configured. Next, the operation of the airbag device will be described.

When no impact is applied to the front bumper of the vehicle from the front of the vehicle seat S by the collision or the like, an operation signal for operating the inflator 41 is not output to the inflator 41 from the controller 99, and the inflation gas G is not supplied to the airbag 50 from the inflator 41. The majority of the airbag 50 excluding the front portion is continuously disposed between the seat pan 13 and the seat cushion 11 in the state of being deployed in a planar shape (see FIGS. 1 and 2).

When the impact is applied to the vehicle from the front of the vehicle seat S by the front collision of the vehicle or the like, the occupant P tries to move forward by inertia. The occupant P is retained on the seat section 10 by the holding action of the seat belt device 30. However, the waist PP may move forward depending on the postures of the occupant P.

Meanwhile, when the impact of a predetermined value or more is applied to the front bumper by the impact from the front and that the impact is detected by the impact sensor 98, an operation signal for operating the inflator 41 is output to the inflator 41 from the controller 99 through the harness 42 on the basis of the detection signal. As illustrated in FIG. 9, depending on the operation signal, in the inflator 41, the gas inflation G starts to be jetted from the gas jetting section 41a. The inflation gas G inflates the inner bag 70 and is released from the gas release holes 83 and 84 of the inner bag 70 to inflate the airbag main body 51.

As described above, by the airbag 50 which is inflated between the seat pan 13 and the seat cushion 11, the seat cushion 11 is pushed upward, and the seat surface 10a of the seat section 10 is raised. A region from the back of the knee PN of the occupant P restrained in the vehicle seat S by the seat belt device 30 to the shoulder PB is pressed upward by the raised seat surface 10a. Especially the waist PP of the occupant P pushed upward by the pressing is pressed against the lap belt section 34 of the seat belt device 30, and the restraining force of the lap belt section 34 rises. A phenomenon in which the waist PP of the occupant P moves forward on the seat section 10 is regulated.

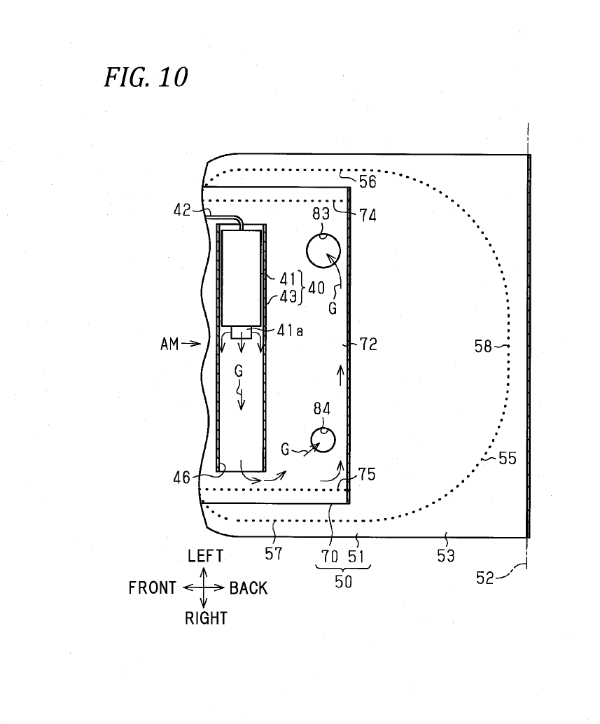

Meanwhile, as illustrated in FIG. 10, a lot of inflation gas G is blown off from the blow-off opening section 46 of one end portion of the gas generator 40 more than from the other end portion. That is, when the inflation gas G is jetted from the gas jetting section 41a of the inflator 41, the most of the inflation gas G is blown off from the blow-off opening section 46 at one end portion of the retainer 43 along the inner wall of the retainer 43. By flowing along the inner wall of the inner bag 70, of both the gas release holes 83 and 84, the inflation gas G first reaches the gas release hole 84 on the side closer to the blow-off opening section 46, and thereafter, the inflation gas reaches the gas release hole 83 on the side remote from the blow-out opening section 46.

However, an opening area of the gas release hole 84 on the side closer to the blow-off opening section 46 is smaller than the opening area of the gas release hole 83 on the side remote from the blow-out opening section 46.

Therefore, between both the gas release holes 84 and 83, a difference in integrated value of the inflation gas G released from the time of the jetting start of the inflation gas G (timing t1) from the gas generator 40 to the passage of a certain time, for example, to the time of jetting termination (timing t2) decreases. Along with this, a difference between the total amount of heat amount released from the gas release hole 84 on the side closer to the blow-off opening section 46 and the total amount of heat amount released from the gas release hole 83 on the side remote from the blow-off opening section 46 decreases.

According to the aforementioned first embodiment, the following effects can be obtained.

(1) Of both the gas release holes 83 and 84 of the inner bag 70, the opening area of the gas release hole 84 on the side closer to the blow-off opening section 46 is set to be smaller than the opening area of the gas release hole 83 on the side remote from the blow-out opening section 46 (FIG. 10).

Therefore, by reducing a difference between the total amount of heat amount released from the gas release hole 83 and the total amount of heat amount released from the gas release hole 84, it is possible to suppress the heat of the inflation gas released from the inner bag from being biased to the airbag main body 51. As a result, it is possible to reduce variation in the vehicle width direction of the influence of the heat of the inflation gas G on the airbag main body 51.

(2) The inflator 41 is disposed inside the retainer 43 while making the side provided with the gas jetting section 41a coincident with the side provided with the opening section 46 of the retainer 43, of the vehicle width direction (FIG. 10).

Therefore, a lot of inflation gas G jetted from the gas jetting section 41a can be blow off from the opening section 46. Further, the inflation gas G can be made to reach the gas release hole 84 on the side closer to the opening section 46, of both the gas release holes 83 and 84, and after that, the inflation gas G can be made to reach the gas release hole 8 on the side remote from the blow-off opening section 46.

### Second Embodiment

Next, a second embodiment embodied in the vehicle airbag device will be described with reference to FIG. 12.

In the aforementioned first embodiment, while both the gas release sections of the inner bag 70 are made up of the gas release holes 83 and 84, in the second embodiment, as illustrated in Section (a) of FIG. 12, of both the gas release sections, the gas release section on the side remote from the blow-off opening section 46 is formed by the gas release hole 83. In contrast, the gas release section on the side closer to the blow-off opening section 46 is made up of a frangible portion 85 which has strength lower than other portions of the inner bag 70 and is ruptured by the inflation gas G to form an opening section 88 in the gas discharge section.

More particularly, the inner bag 70 is formed with four slits 86 that extend radially from each other from starting points that are set at positions spaced apart from each other. Of the inner bag 70, a region surrounded by the starting points of a plurality of slits 86 is formed as a connection section 87 for connecting all the slits 86. Further, the fragile section is constituted by the slits and the connection section.

Other configurations are the same as those of the first embodiment. Therefore, elements similar to those described in the first embodiment are denoted by the same reference numerals and the repeated description will be omitted.

According to the airbag device of the second embodiment having the above configuration, as illustrated in Section (a) of FIG. 12, of both the gas release sections, the gas release section on the side remote from the blow-off opening section 46 is constituted by the gas release holes 83 and is opened. Therefore, although the gas release section (the gas release hole 83) is away from the blow-off opening section 46, the inflation gas G blown off from the opening section 46 can pass through the gas release section.

In contrast, the gas release section on the side closer to the blow-off opening section 46 is constituted by the fragile section 85. Although the fragile section 85 is close to the blow-out opening section 46, until it is ruptured by the inflation gas, the fragile section 85 regulates the passage of the inflation gas through the gas release section. That is, the connection section 87 in the frangible portion 85 is not ruptured by the inflation gas G when the internal pressure of the inner bag 70 is low. All the slits 86 are continuously connected by the connection section 87. Deformation of the portion between the adjacent slits 86 is regulated by the connection section 87. Therefore, the passage of the inflation gas G through the gas release section (fragile section 85) is regulated. However, a slight amount of inflation gas G can pass through the slits 86.

As illustrated in Section (b) of FIG. 12, when the internal pressure of the inner bag rises with the supply of the inflation gas G and the fragile section 85 is ruptured by the inflation gas G, all the slits are not connected. That is, when the internal pressure of the inner bag 70 increases with the supply of the inflation gas G and the connection section 87 is ruptured by the inflation gas G, all the slits 86 are connected. When a portion between the adjacent slits 86 is deformed, the opening section 88 is formed in the gas discharge section. A lot of the inflation gas G more than before rupturing of the connection section 87 can pass through the opening section 88.

Therefore, between the gas release section (fragile section 85) on the side closer to the blow-off opening section 46 and the gas release section (gas release hole 83) on the side remote from the blow-off opening section 46, a difference in integrated value of the inflation gas released from the time of the jetting start of the inflation gas G (timing t1) to the passage of a certain time, for example, to the time of jetting termination (timing t2) decreases. Along with this, a difference between the total amount of heat amount released from the gas release section (opening section 88) on the side closer to the blow-off opening section 46 and the total amount of heat amount released from the gas release hole 83 on the side remote from the blow-off opening section 46 decreases.

Therefore, according to the second embodiment, the same effects as (2) are obtained, and in addition, the following effects can be obtained.

(3) of the two gas release section, the gas release section on the side remote from the blow-off opening section 46 of the gas generator 40 is formed by the gas release hole 83, and the gas release section on the side closer to the blow-off opening section 46 is formed by the fragile section 85 (Section (a) of FIG. 12).

Therefore, it is possible to reduce the difference between the total amount of heat amount released from the gas release hole 83 and the total amount of heat amount released from the opening section 88, and as a result, is possible to obtain the same effect as (1).

(4) The inner bag 70 is formed with four slits 86 that extend radially from each other from the starting points set at the positions spaced apart from each other. The fragile section 85 is made up of all the slits 86, and a joining section 87 that includes a region of the inner bag 70 surrounded by the starting points of all the slits 86 and connects all the slits 86 (Section (a) of FIG. 12).

Therefore, the timing at which the inflation gas G starts to be released from the gas release section on the side closer to the blow-off opening section 46 is set to be slower than the case where the gas release section is made up of the hole, and thus, it is possible to reduce the difference in total amount of released heat amount between both the gas release sections and obtain the same effect as (1).

### Third Embodiment

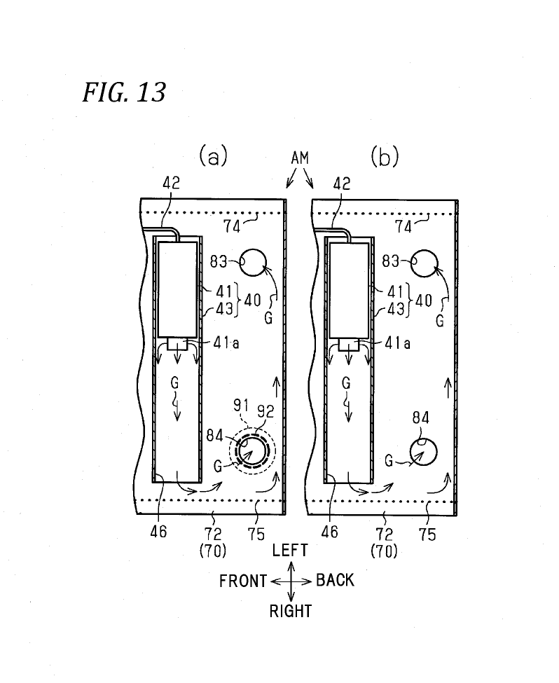

Next, a third embodiment embodied in the vehicle airbag device will be described with reference to FIG. 13.

In the third embodiment, as illustrated in Section (a) of FIG. 13, the gas release hole 83 on the side remote from the blow-off opening section 46 is opened. In contrast, a lid sheet 91 is disposed at the position for closing the gas release holes 84 on the side closer to the blow-off opening section 46. The lid sheet 91 is joined to the inner bag 70, by an annular joining section 92 that surrounds the gas release hole 84 and is ruptured by the inflation gas G.

Other configurations are the same as those of the first embodiment. Therefore, elements similar to those described in the first embodiment are denoted by the same reference numerals and the repeated description will be omitted.

According to the airbag device of the third embodiment having the above configuration, of the gas release sections, the gas release section on the side remote from the blow-off opening section 46 is made up of a gas release hole 83 and is closed. Therefore, the gas release section (gas release hole 83) is away from the blow-off opening section 46, but the inflation gas G blown off from the opening section 46 can pass through the gas release section.

In contrast, the gas release section on the side closer to the opening section 46 is made up of the gas release hole 84, but it is blocked by the lid sheet 91. Moreover, the lid sheet 91 is joined to the inner bag 70 by the annular joining section 92 to regulate the movement. Therefore, until the force of magnitude enough to rupture the annular joining section 92 through the lid sheet 91 by the inflation gas G, the gas release hole 84 is maintained in a state of being blocked by the lid sheet 91. The passage of the inflation gas G through the gas release hole 84 is regulated by the lid sheet 91 and the annular joining section 92.

When the internal pressure of the inner bag 70 rises with the supply of the inflation gas G, the force applied to the annular joining section 92 through the lid sheet 91 increases, and at least a portion of the annular joining section 92 is ruptured, the joining force caused by the annular joining section 92 applied by that time decreases. As illustrated in Section (b) of FIG. 13, at least a portion of the gas release hole 84 is opened, and a lot of inflation gas more than before rupturing of the annular joining section 92 can pass through the gas release hole 84.

Therefore, between the gas release section 84 on the side closer to the blow-off opening section 46 and the gas release section 83 on the side remote from the blow-off opening section 46, a difference in the integrated value of the inflation gas released from the time of jetting start (timing t1) of the inflation gas G from the gas generator 40 to the passage of a certain period of time, for example, to the jetting termination time (timing t2) decreases. Along with this, a difference between the total amount of heat amount released from the gas release hole 84 and the total amount of heat amount released from the gas release hole 83 decreases.

Therefore, according to the third embodiment, the same effects as (2) are obtained, and in addition, the following effects can be obtained.

(5) Of both the gas release holes 83 and 84, the gas release hole 83 on the side remote from the blow-off opening section 46 of the gas generator 40 is opened. The lid sheet 91 is disposed at the position for closing the gas release hole 84 on the side closer to the blow-off opening section 46, and the lid sheet 91 is joined to the inner bag 70 by the annular joining section 92 (Section (a) of FIG. 13).

Therefore, the timing at which the inflation gas G starts to be released from the gas release hole 84 on the side closer to the blow-off opening section 46 can be set to be slower than the timing at which the inflation gas G starts to be released from the gas release hole 83 on the side remote from the blow-off opening section 46. It is possible to reduce a difference in total amount of released heat amount between both the gas release sections, and as a result, it is possible to obtain the same effect as (1).

### Fourth Embodiment

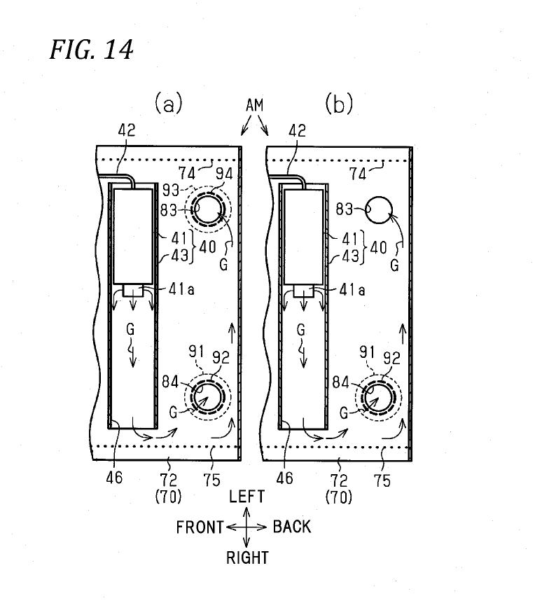

Next, a fourth embodiment embodied in the vehicle airbag device will be described with reference to FIG. 14.

In the fourth embodiment, as illustrated in Section (a) of FIG. 14, in addition to the lid sheet 91 for closing the gas release hole 84, a lid sheet 93 is also disposed at a position for blocking the gas release hole 83 on the side remote from the blow-off opening section 46. The lid sheet 93 surrounds the gas release hole 83 and is joined to the inner bag 70 by an annular joining section 94 that is ruptured by the inflation gas G. However, as the annular joining section 94, a section which is ruptured with force smaller than the annular joining section 92 for joining the lid sheet 91 to the inner bag 70 is used. In this way, in order to vary the force required to rupturing between the annular joining sections 92 and 94, the annular joining sections 92 and 94 are formed of sewing yarns of types with different strengths. Instead of this, the same kind of sewing yarns with different thicknesses may be used. In addition, the pitches of the sewing may also be varied between the annular joining sections 92 and 94.

Other configurations are the same as those of the third embodiment. Therefore, elements similar to those described in the third embodiment are denoted by the same reference numerals and the repeated description will be omitted.

According to the airbag device of the fourth embodiment having the above configuration, both the gas release sections are constituted by the gas release holes 83 and 84 and are blocked by the lid sheets 91 and 93. Moreover, the lid sheets 91 and 93 are joined to the inner bag 70 by the annular joining sections 92 and 94 to regulate the movement. Therefore, until the force of magnitude enough to rupture the annular joining sections 92 and 94 through the lid sheets 91 and 93 by the inflation gas G, each of the gas release holes 84 and 83 is maintained in a state of being blocked by the lid sheets 91 and 93. The passage of the inflation gas B through the gas release holes 84 and 83 is regulated by the lid sheets 91 and 93 and the annular joining sections 92 and 94.

However, in the gas release hole 84 on the side of closer to the blow-off opening section 46, the lid sheet 91 is joined to the inner bag 70 by the annular joining section 92 which is ruptured with force greater than the gas release hole 83 on the remote side.

Therefore, when the internal pressure of the inner bag 70 rises with the supply of the inflation gas G and the force applied to the annular joining sections 92 and 94 through each of the lid sheets 91 and 93 increases, as illustrated in Section (b) of FIG. 14, only in the gas release portion on the side remote from the blow-off opening section 46, at least a portion of the annular joining section 94 joined to the lid sheet 93 is ruptured. The joining force caused by the annular joining section 94 applied by that time decreases, at least a portion of the gas release hole 83 is opened, and a lot of inflation gas G more than before rupturing of the annular joining section 94 can pass through the gas release hole 83.

Even after that, when the internal pressure of the inner bag 70 continues to rise with the supply of the inflation gas G, even in the gas release section 84 on the side closer to the blow-off opening section 46, at least a portion of the annular joining section 92 joined to the lid sheet 91 is ruptured. The joining force caused by the annular joining section 92 applied by that time decreases, at least a portion of the gas release hole 84 is opened, and a lot of inflation gas more than before rupturing of the annular joining section 92 can pass through the gas release hole 84.

In this way, at the time of jetting start (timing t1) of the inflation gas from the gas generator 40, all the gas release holes 84 and 83 are also blocked by the lid sheets 91 and 93. However, the gas release hole 83 on the side remote from the blow-off opening section 46 is opened, and the gas release hole 84 on the side closer to the blow-out opening section 46 is opened later than that.

Therefore, between the gas release hole 84 and the gas release hole 83, a difference in the integrated value of the inflation gas G released from the time of jetting start (timing t1) of the inflation gas G to the passage of a certain period of time, for example, to the jetting termination time (timing t2) decreases. Along with this, a difference between the total amount of heat amount released from the gas release hole 84 and the total amount of heat amount released from the gas release hole 83 decreases.

Therefore, according to the fourth embodiment, the same effects as (2) are obtained, and in addition, the following effects can be obtained.

(6) Lid sheets 91 and 93 are disposed at the position for blocking each of the gas release holes 84 and 83. The lid sheets 91 and 93 surround the gas release holes 84 and 83 and are joined to the inner bag 70 by annular joining sections 92 and 94 that are ruptured by the inflation gas G. The lid sheet 91 on the side closer to the blow-off opening section 46 is joined to the inner bag 70 by the annular joining section 92 that is ruptured by force greater than the lid sheet 93 on the remote side (Section (a) of FIG. 14).

Therefore, with such a configuration, the timing at which the inflation gas G starts to be released from the gas release hole 84 on the side closer to the blow-off opening section 46 can be set to be slower than the timing at which the inflation gas G starts to be released from the gas release hole 83 on the side remote from the blow-off opening section 46. It is possible to reduce the difference in total amount of released heat amount between both the gas release sections, and as a result, the same effect as (1) can be obtained.

Further, each of the above embodiments can also be provided as modified examples modified as follows.
The flap section 65 and the inner flap section 76 may be maintained in the folded state by a separate mechanism without using the bolt 44.
The flap section 65 and the inner flap section 76 may be omitted. In this case, for example, after the gas generator 40 is disposed in the inner bag 70 inside the airbag main body 51, the upper fabric section 53 and the lower fabric sections 54 of the airbag main body 51 are joined in the vicinity of the outer insertion port 62 by sewing or the like, and the upper inner fabric section 72 and the lower inner fabric section 73 on the inner bag 70 may be joined in the vicinity of the inner insertion port 77 by sewing or the like. The sewing may be performed by a common sewing yarn.
The inner bag 70 and the gas generator 40 may be located at the positions different from the above embodiment in the airbag main body 51, for example, on the rear end portion in the vehicle longitudinal direction.
The airbag main body 51 and the inner bag 70 may be disposed inside the seat section 10 in a folded state (between the seat cushion 11 and the seat pan 13).
The substantially overall airbag main body 51 may be constituted by the inflation unit, and may partially have a non-inflation section portion that is not supplied with the inflation gas G and is not inflated.
The gas release section of the inner bag 70 may be provided on only one of the upper inner fabric sections 72 and the lower inner fabric section 73.
In the second embodiment, the number of slits 86 may be changed to three or five or more. In either case, the slits 86 are formed to extend radially from each other from the starting points that are set at the positions spaced apart from each other.
In the airbag device, the inner bag 70 is also applicable to an airbag device that has the gas release sections at three or more positions spaced apart from each other in the width direction of the vehicle seat S.

For example, in the first embodiment, in the inner bag 70, the gas release holes as the gas release sections may be provided at three or more positions spaced apart from each other in the width direction of the vehicle seat S. In this case, the opening area of the gas release hole is set so that the opening area becomes minimum in the gas release hole nearest to the blow-off opening section 46 and becomes larger as it is away from the blow-out opening section 46.

In the second embodiment, of the gas release sections of the inner bag 70, the gas release section farthest from the blow-off opening section 46 may be constituted by the gas release hole, and the remaining gas release section may be constituted by the fragile section 85. In this case, the fragile section 85 is formed so that its strength increase as it approaches the blow-off opening section 46 and the fragile section 85 is less likely to be ruptured by the inflation gas G.

In the third embodiment, in the inner bag 70, the gas release holes as the gas release sections may be a provided at three or more positions spaced apart from each other in the width direction of the vehicle seat S. In this case, the gas release hole farthest from the blow-off opening section 46 is opened. The lid sheets 91 are located at positions for closing the remaining gas release holes, and each lid sheet 91 is joined to the inner bag 70 by the annular joining section 92. The annular joining section 92 is formed so that the strength (joining strength) of joining the lid sheets 91 to the inner bag 70 becomes higher as it approaches the blow-off opening section 46.

In the fourth embodiment, in the inner bag 70, the gas release holes as the gas release sections may be provided at three or more positions spaced apart from each other in the width direction of the vehicle seat S. In this case, the lid sheets are located at the positions for closing all the gas release holes, and each lid sheet is joined to the inner bag 70 by the annular joining section. The annular joining section is formed so that the strength (joining strength) of joining the lid sheets to the inner bag 70 becomes higher as it approaches the blow-off opening section 46.
Other than the occupant P, for example, luggage and the like may be used as the restraint target object of the airbag device. Even when the luggage is placed on the seat section 10 as the restraint target object, the same effects as the above embodiments can be obtained.
The airbag device is also applicable to the vehicle seat S that is disposed in the vehicle to face the direction that is different from the longitudinal direction of the vehicle, for example, an orthogonal direction (vehicle width direction), when the occupant P is seated. Further, the airbag device can be applied to any of a plurality of the vehicle seats S which are arranged in the passenger compartment in the longitudinal direction.
In the airbag device, as a support, in place of the seat pan 13, a portion of the seat frame can be applied to a vehicle seat of the type constituted by a stretched wireframe section.
The vehicle to which the airbag device is applied also includes various industrial vehicles without being limited to the private car.
The airbag device is also applicable to an airbag device that is installed in a vehicle seat in other vehicles such as an aircraft and a ship, without being limited to the vehicle.

What is claimed is:

1. A seat cushion airbag device comprising:
an airbag disposed in a seat section of a vehicle seat; and
a gas generator which has an elongated shape extending in a width direction of the vehicle seat within the airbag and blows off a lot of inflation gas from a blow-off opening section of one end portion more than from the other end portion,
the airbag including:
an airbag main body which constitutes an outer shell portion; and
an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein:
the inner bag and the airbag main body are inflated by the inflation gas to raise the seat surface of the seat section to regulate a restraint target object on the seat section from moving forward; and
each of the gas release sections is constituted by a gas release hole, and of the gas release holes, an opening area of the gas release hole on the side closer to the blow-off opening section is set to be smaller than an opening area of the gas release hole on the remote side.

2. A seat cushion airbag device comprising:
an airbag disposed in a seat section of a vehicle seat; and
a gas generator which has an elongated shape extending in a width direction of the vehicle seat within the airbag and blows off a lot of inflation gas from a blow-off opening section of one end portion more than from the other end portion,
the airbag including:
an airbag main body which constitutes an outer shell portion; and
an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein:
the inner bag and the airbag main body are inflated by the inflation gas to raise the seat surface of the seat section to regulate a restraint target object on the seat section from moving forward; and
a gas release section, of the gas release sections, on the side remote from the blow-off opening section is constituted by a gas release hole, and a gas release section, of the gas release sections, on the side closer to the blow-off opening section is constituted by a fragile section which has strength lower than other positions of the inner bag and is ruptured by the inflation gas to form an opening section in the gas release section.

3. The seat cushion airbag device according to claim 2, wherein:
the inner bag is formed with a plurality of three or more slits extending radially from each other from starting points that are set at positions spaced apart from each other; and
the fragile section is constituted by the plurality of slits, and a joining section that is made up of a region surrounded by the starting points of all the slits and connects all the slits.

4. A seat cushion airbag device comprising:
an airbag disposed in a seat section of a vehicle seat; and
a gas generator which has an elongated shape extending in a width direction of the vehicle seat within the airbag and blows off a lot of inflation gas from a blow-off opening section of one end portion more than from the other end portion,
the airbag including:
an airbag main body which constitutes an outer shell portion; and
an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein:
the inner bag and the airbag main body are inflated by the inflation gas to raise the seat surface of the seat section to regulate a restraint target object on the seat section from moving forward; and
each of the gas release sections is constituted by the gas release holes, the gas release hole on the side remote from the blow-off opening section is opened, a lid sheet is located at a position of closing the gas release hole on the side closer to the blow-off opening section, and the lid sheet surrounds the gas release holes and is connected to the inner bag by an annular joining section which is ruptured by the inflation gas.

5. A seat cushion airbag device comprising:
an airbag disposed in a seat section of a vehicle seat; and
a gas generator which has an elongated shape extending in a width direction of the vehicle seat within the airbag and blows off a lot of inflation gas from a blow-off opening section of one end portion more than from the other end portion,
the airbag including:
an airbag main body which constitutes an outer shell portion; and
an inner bag which is disposed inside the airbag main body in the state of wrapping the gas generator and has gas release sections configured to release the inflation gas from the gas generator to the airbag main body in at least two positions spaced apart from each other in the width direction of the vehicle seat, wherein:
the inner bag and the airbag main body are inflated by the inflation gas to raise the seat surface of the seat section, thereby regulating a restraint target object on the seat section from moving forward; and
each of the gas release sections is constituted by gas release holes, lid sheets are disposed at positions for closing each gas release hole, the lid sheets surround the gas release holes and are joined to the inner bag by the annular joining section ruptured by the inflation gas, and the lid sheet on the side closer to the blow-out opening section is joined to the inner bag by an annular joining section which is ruptured with force greater than the lid sheet on the remote side.

6. The seat cushion airbag device according to claim 1, wherein:
the gas generator includes:
a retainer which has a cylindrical shape extending in the width direction of the vehicle seat and has the blow-off opening section at one end portion thereof; and
an inflator which has an elongated shape extending in the width direction of the vehicle seat and has a gas jetting section at one end portion; and
the inflator is disposed inside the retainer in a state in which the provision side of the gas jetting section is made to coincide with the provision side of the blow-off opening section of the retainer, in the width direction of the vehicle seat.

7. The seat cushion airbag device according to claim 2, wherein:
the gas generator includes:
a retainer which has a cylindrical shape extending in the width direction of the vehicle seat and has the blow-off opening section at one end portion thereof; and
an inflator which has an elongated shape extending in the width direction of the vehicle seat and has a gas jetting section at one end portion; and
the inflator is disposed inside the retainer in a state in which the provision side of the gas jetting section is made to coincide with the provision side of the blow-off opening section of the retainer, in the width direction of the vehicle seat.

8. The seat cushion airbag device according to claim 4, wherein:
the gas generator includes:
a retainer which has a cylindrical shape extending in the width direction of the vehicle seat and has the blow-off opening section at one end portion thereof; and
an inflator which has an elongated shape extending in the width direction of the vehicle seat and has a gas jetting section at one end portion; and
the inflator is disposed inside the retainer in a state in which the provision side of the gas jetting section is made to coincide with the provision side of the blow-off opening section of the retainer, in the width direction of the vehicle seat.

9. The seat cushion airbag device according to claim 5, wherein:
the gas generator includes:
a retainer which has a cylindrical shape extending in the width direction of the vehicle seat and has the blow-off opening section at one end portion thereof; and
an inflator which has an elongated shape extending in the width direction of the vehicle seat and has a gas jetting section at one end portion; and
the inflator is disposed inside the retainer in a state in which the provision side of the gas jetting section is made to coincide with the provision side of the blow-off opening section of the retainer, in the width direction of the vehicle seat.
